(19) United States
(12) Patent Application Publication
(10) Pub. No.: US 2011/0090401 A1
(43) Pub. Date: Apr. 21, 2011

(54) System and Method for Triggering a Demonstration Mode of a Display Device

(75) Inventors: Brant Candelore, San Diego, CA (US); Peter Shintani, San Diego, CA (US)

(73) Assignees: SONY CORPORATION, Tokyo (JP); SONY ELECTRONICS INC., Park Ridge, NJ (US)

(21) Appl. No.: 12/582,452

(22) Filed: Oct. 20, 2009

(51) Int. Cl. H04N 5/445; H04N 7/173

(52) U.S. Cl. 348/563; 725/109; 348/E05.099

(57) ABSTRACT

A system and method are provided for triggering a demonstration mode of a display device. In one embodiment, a process includes displaying data received by a first input of the display device, monitoring a broadcast channel by the display device, and detecting a triggering signal in the broadcast channel. The process may also include displaying a demonstration based on detection of the triggering signal. Once the demonstration is complete, data received by the first input may be displayed.

### FIELD OF THE INVENTION

The present invention relates generally to display devices, and more particularly to a system and method for triggering a demonstration mode of a display device.

### BACKGROUND OF THE INVENTION

Retailers of television devices typically display one or more television units for customers. In a retail environment, televisions on display are typically coupled to a house feed. The house feed allows for customers to view content on a television unit. However, in certain instances, a house feed may not provide signaling which displays the television unit's performance. As such, customers may not view an accurate representation of the quality that a television may produce. This may be due to splitting of the feed signal, type of connection coupled to the television unit and even content provided by the feed.

Many retail stores do not allow a customer to access terminals of a television device or provide access to a remote control of the device. Accordingly, even if a display device is configured to provide a demonstration mode or coupled to a different feed, users unfortunately cannot access other inputs which may be coupled to the television. Further, many retailers are paid for providing content to television devices. Thus, many retailers prefer that content shown on the television unit includes the house feed. Thus, there is a desire to provide access to demonstration features of a television device in a retail environment.

### BRIEF SUMMARY OF THE INVENTION

Disclosed and claimed herein are a system and methods for triggering a demonstration mode of a display device. In one embodiment, a method includes displaying data, by a display device, received by a first input of the display device, monitoring a broadcast channel by the display device, and detecting a triggering signal in the broadcast channel. The method additionally includes displaying a demonstration, by the display device, based on detection of the triggering signal. The method further includes displaying data received by the first input when the demonstration is completed.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a simplified block diagram of system for triggering a demonstration mode of a display device according to one embodiment;

FIG. 2 depicts a simplified block diagram of a display device according to one or more embodiments;

FIG. 3 depicts a process for triggering a demonstration mode of a display device according to one or more embodiments;

FIG. 4 depicts a process for transmitting an activation signal according to one or more embodiments; and

FIG. 5 depicts a process for controlling operation of a display device according to one or more embodiments.

### DETAILED DESCRIPTION OF THE EXEMPLARY EMBODIMENTS

### Overview and Terminology

One aspect of the present invention relates to operation of a display device. In one embodiment, a process is provided for triggering a demonstration mode of a display device to provide a demonstration of one or more capabilities of the display device. The process may be initiated by the display device monitoring a broadcast channel for detection of a triggering value. The display device may trigger a demonstration mode when a predetermined triggering signal is detected in the broadcast channel. The display device may then provide a demonstration to one or more of a user and customer of the display device. The process for triggering the demonstration mode may be based on an operation mode of the display device, such that triggering of the display device may be restricted to devices in a retail environment. The triggering signal may include information indicating one or more features for demonstration. Additionally, information may be provided to locate content which may be used with one or more features that are demonstrated. The information may be internal to the display device, external to the display device, and/or sent with the broadcast stream or a separate stream.

In another embodiment, a system may be provided for transmission of one or more signals to a display device for triggering a demonstration mode of the display device. The system may allow for a mobile communication device to interface with a server for transmission of one or more signals to a particular display device. In that fashion, one or more customers viewing a display device in a retail environment may view features of the display device without the aid of an employee of the retail store, without a remote controller of the display device, and without being the need to touch a front panel of the display device. Accordingly the present invention allows for content to be displayed on a display device which may be used to increase sales of the display devices through content presented. Further, the content may be presented with little to no setup by retail stores.

According to another embodiment, triggering signals may be transmitted to control operation of a display device. For example, triggering signals may be employed to trigger a message display on the display device. Alternatively, or in combination, a triggering signal may be transmitted to disable operation of the display device. In that fashion, triggering signals may be employed to deter theft of a display device. Similarly, triggering signals may be employed to control operation of leased display devices.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

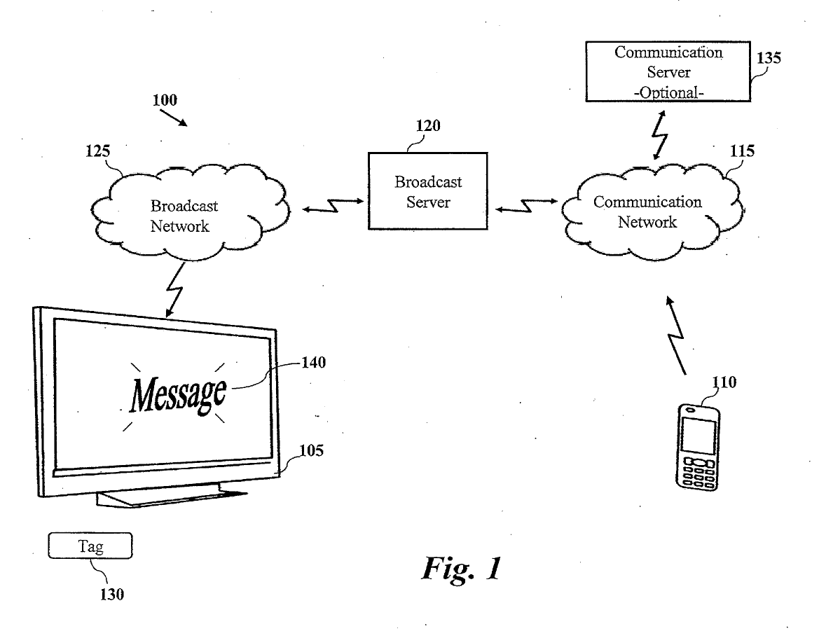

Referring now to the figures, FIG. 1 depicts a simplified block diagram of system for providing a triggering signal to a display device according to one embodiment of the invention. System 100 may allow for at least one of a user and customer to trigger a demonstration of display device 105. According to another embodiment of the invention, system 100 may allow for triggering of display device 105 by a mobile communication device 110. In that fashion, a user may advantageously view a demonstration of the quality and display capabilities of display device 105.

Display device 105 may be configured to provide a demonstration, to provide a user and/or customers of the operating characteristics and abilities of the display device. As used herein, the demonstration may relate to a presentation that contains audio and video content which may be displayed by display device 105. In that fashion, display device 105 may allow for a user to view capabilities of display device 105 which may not be apparent in a retail environment from a house feed, for example. The demonstration may be stored in the memory of a display device and may be triggered by user navigating an interface of display device 105. In certain embodiments, display device 105 may be configured to operate in one or more modes. In a retail mode, for example, triggering of a demonstration may be based on receiving one or more broadcast signals by display device 105. For example, a particular code may be transmitted within a broadcast transmission which may be detected by display device 105.

System 100 includes broadcast server 120 which may be configured to communicate with mobile device 110 via communication network 115. Broadcast server 120 may transmit one or more triggering signals to display device 105 using broadcast network 125. Communication network 115 may relate to one or more of a telephone network, cellular communication network, internet protocol (IP) network, etc. Broadcast network 125 relates to one or more broadcasters for providing over-the-air signaling including radio, TV and media content in general.

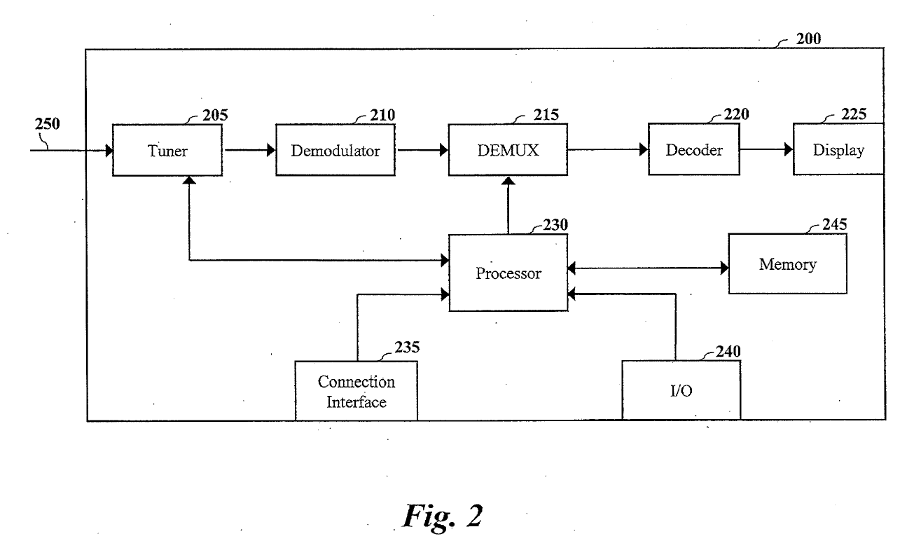

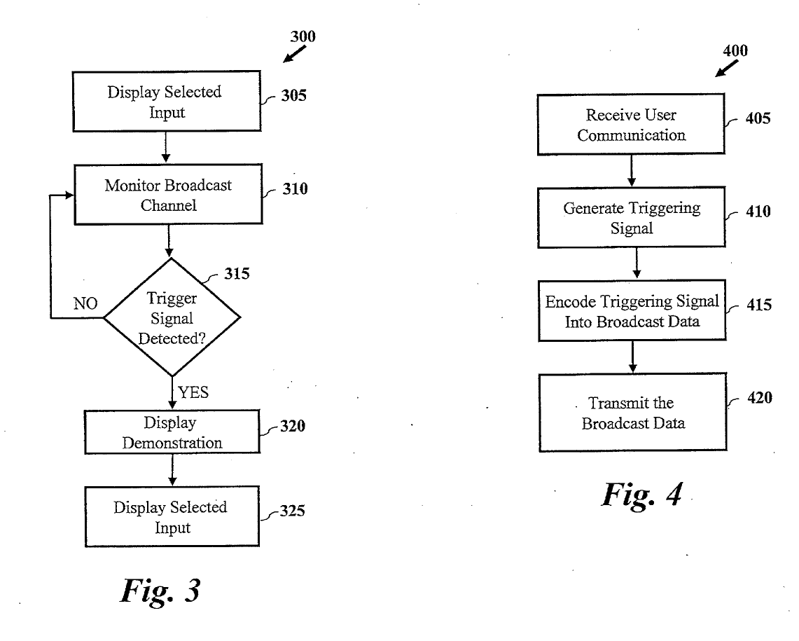

According to another embodiment, information may be provided to a customer in a retail environment. As shown in FIG. 1, a tag 130 may be displayed near display device 105. For example, in a retail environment, the tag 130 may be displayed on a support structure and/or on display device 105. It may be represented as electronic Point-of-Purchase (EPOP) and displayed on-screen by the display device 105. A user having a mobile communication device, such as mobile communication device 110, can dial communication identifier (e.g. telephone number) on tag 130 for triggering a presentation mode of display device 105. In one embodiment, a user may be prompted to enter a code or serial number that will uniquely identify the display device or group of display devices as will be described in more detail below with respect to FIG. 3. Based on a received code, broadcast server 120 may be configured to embed one or more triggering signals into a broadcast stream. When the display device 105 detects a triggering signal embedded in a broadcast stream, the display device 105 may be configured to trigger a demonstration mode. As will be described below with reference to FIG. 2, a tuner of display device 105 may be configured to monitor a broadcast data.

According to another embodiment, system 100 may include optional communication server 135 configured to receive one or more communication requests from mobile communication device 110. The communication server 135 may be configured to provide prompts to the user in order to get the identifying code. The communication server 135 then sends one or more triggering signals to the broadcast server 120 for transmission to one or more display devices. Although FIG. 1 is described with reference to display devices, it may be appreciated that system 100 may apply to other types of devices (e.g. set-top box or mobile handheld device).

According to another embodiment, system 100 may allow for selective distribution of a triggering signal to display devices. For example, a broadcast server can determine which base station or transmitter of broadcast network 125 for transmission of a triggering signal to a display device. Selection of the triggering signal may be determined based on a code received from mobile communication device 110. In certain embodiments, code values associated with a display device may relate to one or more of a single display unit, model of a display unit, zip code of a display unit and geographic identifier in general. The code values may additionally include information regarding a type of demonstration display device 105 is to perform. Further, the code values may also provide data regarding the type of content the display device 105 is to use for the demonstration. For example, certain demonstrations may be performed using retailer content. In other embodiments, demonstrations may be best performed using content stored internally or externally of the display device 105. Although some content may be more illustrative of a feature to be showcased, a certain retailer may wish to display retailer content. Location associated with one or more codes of display devices may be stored, for example by broadcast server 120, such that broadcast signals are transmitted to a limited area.

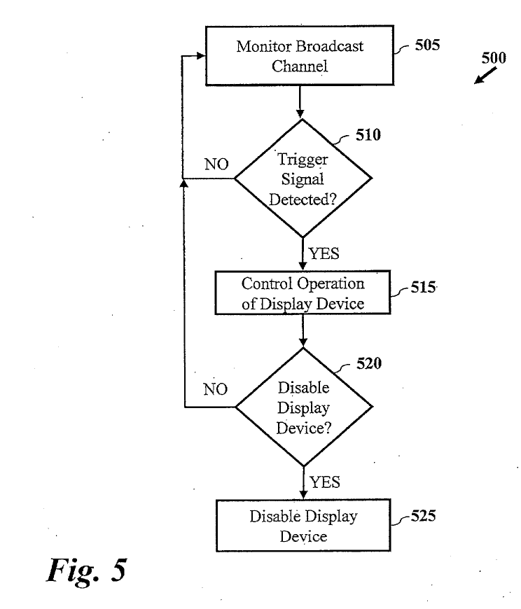

In certain embodiments, display device 105 may be configured to display a message, shown as 140 in FIG. 1 when a triggering signal is received. Messages for display by display device 105 may relate to emergency notifications and/or reminders. By way of example, when display device 105 is used for as a rental device, one or more messages may be displayed based on a triggering signal as a reminder that payment is due. As will be discussed in more detail below with reference to FIG. 5, triggering signals may be transmitted to disable operation of display device 105 when payments are outstanding and/or the display device is stolen. Identification of display devices which are leased and/or include theft deterrent capabilities may be stored by communication server 135.

Referring now to FIG. 2, a simplified block diagram is shown of the display device of FIG. 1 according to one or more embodiments of the invention. In one embodiment, display device 200 (e.g., display device 105) may be configured to output video and audio data based on one or more received signals. Display device 200 includes tuner 205, demodulator 210 (e.g., image sensor 160), demultiplexer 215, decoder 220 and display 225 to provide video image data based on one or more signals received by tuner 205. For example, display device 200 may be configured to display video data such as ATSC, DVB-T, ISDB-T, and digital broadcasting formats in general. Display device 200 may also be configured to output video and audio data based on one or more signals received by connector interface 235. Connector interface 235 may be coupled to one or more of a set-top box, video disc player (e.g., DVD, Blu-ray™, etc.) and/or media player in general. Data received by display device 200 may be processed by processor 230 for display.

Display device 200 may be configured to provide a demonstration to allow display device 200 to output video and/or audio data as an example of display capabilities and/or performance of the device. Demonstration data and instructions may be stored in memory 245 and accessed by processor 230 according to one or more embodiments. In certain embodiments, a user and/or retailed may set the display device in a retail mode using input/output (I/O) interface 240. When display device 200 is in a standard operating mode (e.g., a non-retail mode), the display device may be configured to ignore detection of a triggering signal for demonstration purposes. Alternatively, when display device 200 is in a retail mode, the display device may monitor one or more broadcast channels for a triggering signal. Because only a portion of particular models of display devices will be used as display models, the retail mode may be set during initialization of display device 200. In that fashion, a demonstration mode may only be triggered for devices in a retail environment.

User access to a retail mode may be achieved by I/O interface 240 and a graphical interface of display device 200. In certain embodiments, activation of a retail mode may be based on a required activation code that may be input by a retailer. Once display device is programmed in a retail mode, tuner 205 may monitor received broadcast signals 250. According to another embodiment, additional steps may be required for enabling a demonstration mode. For example, certain display devices may require additional enablement requirements on initialization in addition to selection of an operational mode.

According to another embodiment, display device 200 may be configured to decode received broadcast signals (shown as 250) and monitor received broadcast signals to detect a triggering signal as will be described in more detail below with respect to FIG. 3. When a particular triggering code is decoded from a received broadcast stream, display device 200 may be configured to trigger a demonstration mode of the device.

Referring now to FIG. 3, a process is depicted for operation of the display device of FIG. 1 according to one embodiment. Process 300 may be initiated by the display device (e.g., display device 105) in a retail mode according to one embodiment of the invention. Process 300 may be initiated when power is applied to the display device, the display device may be configured to output video and/or audio data based on a selected input, such as a previously selected input (e.g., house feed), at block 305. In the retail mode, the display device may also monitor one or more broadcast channels at block 310 while displaying a selected input channel. In that fashion, the display device may be coupled to a house feed in a retail store for example, while monitoring one or more wireless broadcast signals. The display device may be configured to monitor one or more over-the-air broadcast signals and/or a particular channel.

Process 300 proceeds by the display device detecting if a demonstration signal has been received at block 315. For example, the display device may be configured to decode a broadcast channel and monitor the broadcast stream for one or more particular codes. When a triggering signal is not received (“NO” path out of decision block 315), the display device continues to monitor a broadcast channel at block 310. When a triggering signal is received (“YES” path out of decision block 315) the display device may display a demonstration stored on the display device at block 320. According to one embodiment, the triggering signal may be based on a user transmission of a code to a broadcast server wherein the code may be associated with one or more of a particular display device, brand and/or model of a display device.

When the demonstration mode is complete, the display device may be configured to display the previously selected input at block 325 (e.g., house feed). In that fashion, display devices in a retail environment may be triggered by a user having a personal communication device for a short period of time and then automatically display a house feed. Accordingly, an advantage of the invention may be to allow for a demonstration mode of the display device to be provided with little to now assistance from a store employee and without the need of navigating a user interface of the display device. A further advantage may be that a retailer may provide particular content while allowing for users to view demonstration mode. Because the display device is seeking a particular code, other display devices in a retail environment may not be affected.

Referring now to FIG. 4, a process is depicted for operation of the broadcast server of FIG. 1 to one or more embodiments. Process 400 may be initiated following user and/or customer initiation of a communication with a broadcast server (e.g., broadcast server 120), such as a mobile communication device (e.g., mobile communication device 110) placing a call to a number listed on a tag (e.g., tag 130) associated with the display device. The broadcast server can receive the user communication at block 405. In certain embodiments the broadcast server may prompt for the device for an activation code. For example, when the user communication relates to a voice telephone call, the broadcast server may provide an automated answering service to prompt the user/customer for an activation code that is listed near to or on the display device. In other embodiments, the broadcast server may receive a communication which includes a code, such as a text message. The broadcast server can generate triggering signals at block 410 based on the type of communication and/or code employed by the user. Based on the particular code received, the broadcast server can encode the triggering signal into a broadcast data channel at block 415 and transmit an activation signal at block 420. Encoding a triggering signal into a broadcast signal by the broadcast server may be based on one or more of the code, location of the display device, a serial number of the display device, and broadcast format.

According to another embodiment, triggering signals encoded at block 415 may be employed to trigger a display message (e.g., message 140) on the display device. Triggering signals encoded at block 415 may similarly be transmitted to disable operation of a display device. As will be discussed in more detail below with reference to FIG. 5, triggering signals may be employed to deter theft of a display device. Similarly, triggering signals may be employed to control operation of a leased display device.

In certain embodiments, triggering signals encoded into a broadcast stream by the broadcast server may affect only a limited number of display devices in the broadcast area. For example, by encoding one or more values associated with a serial number, zip code and/or group access key, only display devices associated with one or more of the aforementioned values will trigger a demonstration mode. According to another embodiment, it may also be appreciated that a call processor (e.g., optional communication server 135) may be configured to perform one or more of the acts of FIG. 4.

Referring now to FIG. 5, a process is depicted for controlling operation of the display device of FIG. 1 according to one embodiment. In certain embodiments, triggering signals may be employed for control of a leased display device. By way of example, triggering signals may be employed to trigger display of a message to a user of the display device that payment is due. Additionally, when payment is not received by the owner of the display device, a triggering signal may be transmitted to disable the display device. According to another embodiment, triggering signals may be employed to deter theft of a display device. The display device may be labeled and/or include a notification that the device is protected by a theft deterrent capabilities which will disable operation of the device in the event the device is stolen.

Process 500 may be initiated by the display device (e.g., display device 105) in a rental mode according to one embodiment of the invention. It should also be appreciated that process 500 may be employed by other modes of operation, including but not limited to a demonstration mode, theft deterrent mode and normal operation mode. Process 500 may be initiated when power is applied to the display device. At block 505, the display device can monitor one or more broadcast channels while displaying a selected input channel.

Process 500 proceeds by detecting if a triggering signal has been detected at block 510. When a triggering signal is not received (“NO” path out of decision block 510), the display device continues to monitor a broadcast channel at block 505. When a triggering signal is received (“YES” path out of decision block 510) operation of the display device may determined based on the triggering signal at block 515. For example, when the triggering signal is associated with providing a reminder that payment is due for a leased display device, the display device can output a reminder message at block 515 that payment is due. Alternatively, when the triggering signal has been transmitted in response to theft of the display device, a message may be displayed indicating that the device is stolen and will be disabled. It should also be appreciated that various messages and/or types of information may be displayed by the message. Further, the message data may be included with a triggering signal according to another embodiment.

Process 500 may then determine if the triggering signal indicates that the display device requires disabling at block 520. According to one embodiment, when payment is overdue, a triggering signal may be transmitted to disable the display device. When the triggering signal does not indicate that the device is to be disabled (“NO” path out of decision block 520), the display device may continue to monitor a broadcast channel at block 505. When the triggering signal indicates disabling of the display device (“YES” path out of decision block 510) the display device can disable operation at block 525. In that fashion, leased display devices may be disabled when payment is not received. In a similar fashion, the triggering signal may be transmitted in response to theft of the display device. As such, the triggering signal may render the display device inoperable when stolen.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for triggering a demonstration mode of a display device, the method comprising the acts of:
displaying data, by the display device, received by a first input of the display device;
monitoring a broadcast channel by the display device;
detecting a triggering signal in the broadcast channel;
displaying a demonstration, by the display device, based on detection of the triggering signal; and
displaying data received by the first input when the demonstration is completed.

2. The method of claim 1, wherein the first input is coupled to one of a house feed, a media player, a network, and broadcast data source.

3. The method of claim 1, wherein monitoring the broadcast channel comprises decoding one or more channels of received broadcast data for detection of the triggering signal.

4. The method of claim 1, wherein the demonstration relates to video and audio data which may be output to present one or more of features and display characteristics of the display device in a retail environment.

5. The method of claim 1, wherein the triggering signal is encoded into a broadcast channel based on a user transmission to a broadcast server.

6. The method of claim 1, wherein the triggering signal relates to at least one of an identification number of the display device, serial number, group number, geographic zip code, flag value.

7. The method of claim 1, wherein the triggering signals is based on a code displayed in close proximity to the display device.

8. A system comprising:
a server configured to broadcast data and receive one or more transmissions from a communication network; and
a display device configured to receive broadcast data transmitted by the server over a broadcast network, the display device configured to:
display data received on a first input of the display device;
monitor a broadcast channel;
detect a triggering signal in the broadcast channel;
control operation of the display device based on the triggering signal.

9. The system of claim 8, wherein monitoring the broadcast channel comprises decoding one or more channels of received broadcast data for detection of the triggering signal.

10. The system of claim 8, wherein controlling operation by the display device relates to display of a demonstration based on detection of the triggering signal and display of data received by the first input when the demonstration is completed.

11. The system of claim 10, wherein the first input is coupled to one of a house feed, a media player, a network, and a broadcast data source.

12. The system of claim 10, wherein the demonstration relates to video and audio data which may be output to present one or more of features and display characteristics of the display device in a retail environment.

13. The system of claim 8, wherein server is further configured to encode the triggering signal into a broadcast channel based on a user transmission to the server.

14. The system of claim 8, wherein the code relates to at least one of an identification number of the display device, serial number, group number, geographic zip code, flag value.

15. The system of claim 8, wherein the triggering signal is based on a code displayed in close proximity to the display device.

16. The system of claim 8, wherein controlling operation by the display device relates to display of a message that payment is required.

17. The system of claim 8, wherein controlling operation by the display device relates to disabling the display device.

18. A method for transmitting a triggering signal by a server to a display device, the method comprising the acts of:
receiving a user communication, by the server, associated with the display device;
generating a triggering signal associated with the display device based on the user communication;
encoding the triggering signal into a broadcast transmission channel of a broadcast data stream; and
transmitting the broadcast data stream.

19. The method of claim 18, wherein the triggering signal is encoded into a broadcast channel based on a user communication to a broadcast server, the user communication relating to one of a voice and messaging service transmission.

20. The method of claim 18, wherein the triggering signal relates to at least one of an identification number of the display device, serial number, group number, geographic zip code, and flag value.

21. The method of claim 18, wherein the triggering signal is generated for triggering a demonstration by a display device.

22. The method of claim 18, wherein the triggering signal is generated for triggering a message that a payment is required.

23. The method of claim 18, wherein the triggering signal is generated to disable the display device.

24. A method for controlling operation of a display device, the method comprising the acts of:
monitoring a broadcast channel by the display device;
detecting a triggering signal in the broadcast channel; and
disabling operation of the display device based on the triggering signal.

25. The method of claim 24, further comprising displaying a message on the display device that a payment is required, wherein the display device is a leased display device.

26. The method of claim 24, wherein disabling operation of the display device is associated with theft deterrent capabilities of the display device.
